(19) United States
(12) Patent Application Publication
(10) Pub. No.: US 2026/0195082 A1
(43) Pub. Date: Jul. 9, 2026

(54) NON-TRANSITORY COMPUTER-READABLE STORAGE MEDIUM STORING PRINTER CONTROL PROGRAM, PRINTER CONTROL DEVICE, AND PRINTER CONTROL METHOD

(71) Applicant: Keita Kouzuma, Susono Shizuoka (JP)

(72) Inventor: Keita Kouzuma, Susono Shizuoka (JP)

(73) Assignee: ETRIA CO., LTD., Kanagawa (JP)

(21) Appl. No.: 19/286,220

(22) Filed: Jul. 30, 2025

(30) Foreign Application Priority Data
Jan. 7, 2025 (JP) 2025-002362

(51) Int. Cl. G06F 3/12

(52) U.S. Cl. CPC G06F 3/1232; G06F 3/1203; G06F 3/1253

(57) ABSTRACT

A non-transitory computer-readable storage medium storing a printer control program controls a printer control device configured to control printers through a network. The program causes a processor of the device to: provide to a user an acquisition environment for acquiring model type information that is preset for each of model types of the printers, acquire the model type information in response to an acquisition request by the user for the model type information, and register the model type information in preset information; provide to the user a selection environment for selecting the model type information from the preset information, and register the model type information selected by the user in set information; and provide to the user an instruction environment for instructing a job to the printer by using the set information, and instruct the job instructed by the user to the printer.

### CROSS-REFERENCE TO RELATED APPLICATION

This application is based upon and claims the benefit of priority from prior Japanese Patent Application No. 2025-002362, filed Jan. 7, 2025, the entire contents of which are incorporated herein by reference.

### FIELD

Embodiments described herein relate generally to a printer control program, a printer control device, and a printer control method.

### BACKGROUND

A printer control device that controls printers disposed in a workplace is known. The printer control device is connected to the printers through a network.

The printer is, for example, a bar code printer. The bar code printer includes various parameters that are necessary for printing. In addition, the number of parameters and the setting ranges of parameters are usually different depending on the model type of the bar code printer.

Printer control programs that are developed exclusively for bar code printers include a mobile application, a desktop application, an SDK (Software Development Kit), and the like. Although these printer control programs are used for various purposes, the printer control programs issue, in the end, print instructions to the bar code printers in many cases.

Accordingly, each printer control program statically stores, as internal information, pieces of preset information, such as parameters and setting ranges necessary for print instructions, as many as the number of model types of bar code printers. Specifically, the preset information is hard-coded. In other words, the preset information is directly embedded in the source code.

### BRIEF DESCRIPTION OF THE DRAWINGS

FIG. 1 is a diagram illustrating an example of a printer system including a printer control device according an embodiment.

FIG. 2 is a diagram illustrating an example of a part of model type information described in an XML format type.

FIG. 3 is a diagram illustrating an example of a sequence of a printer control operation by the printer control device.

FIG. 4 is a diagram illustrating an acquisition UI screen of an acquisition UI that is an acquisition environment for acquiring model type information of a printer.

FIG. 5 is a diagram illustrating a selection UI screen of a selection UI that is a selection environment for selecting model type information of the printer.

FIG. 6 is a diagram illustrating a setting instruction UI screen of a job instruction UI for instructing a job of print setting update to a printer.

### DETAILED DESCRIPTION

A non-transitory computer-readable storage medium storing a printer control program according to the embodiment controls a printer control device configured to control printers connected to the printer control device through a network. The printer control program causes a processor of a computer constituting the printer control device to: provide to a user an acquisition environment for acquiring model type information that is preset for each of model types of the printers, acquire the model type information in response to an acquisition request by the user for the model type information, and register the model type information in preset information; provide to the user a selection environment for selecting the model type information from the preset information, and register the model type information selected by the user in set information; and provide to the user an instruction environment for instructing a job to the printer by using the set information, and instruct the job instructed by the user to the printer.

Hereinafter, embodiments are described with reference to the accompanying drawings.

### Printer Control Device

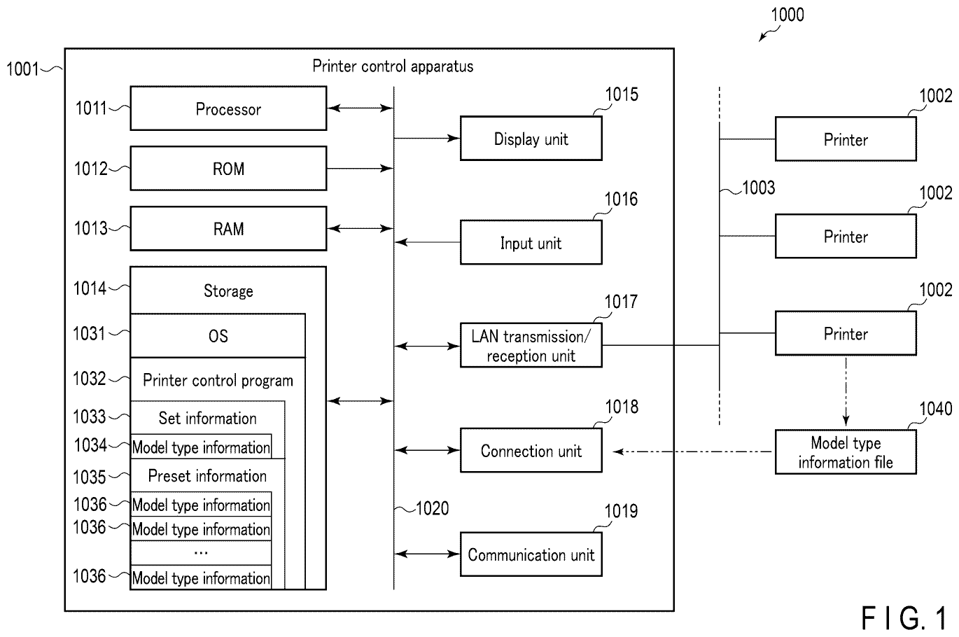

To begin with, referring to FIG. 1, a printer system 1000 including a printer control device 1001 according to an embodiment is described. FIG. 1 is a diagram illustrating an example of the printer system 1000 including the printer control device 1001 according the embodiment.

The printer system 1000 includes the printer control device 1001 and printers 1002. The printer control device 1001 is connected to the printers 1002 through a network, for example, a local area network (LAN) 1003. The printer control device 1001 and each printer 1002 can communicate with each other through the LAN 1003.

The printer control device 1001 instructs each printer 1002 to execute settings and a job such as print. For example, the printer control device 1001 is composed of a computer.

The printer 1002 executes settings, print, or the like, upon receiving an execution instruction of a job from the printer control device 1001. The printer 1002 is, for example, a bar code printer. The bar code printer is, for example, a thermal printer including a thermal head.

The printer control device 1001 includes a processor 1011, a read-only memory (ROM) 1012, a random access memory (RAM) 1013, a storage 1014, a display unit 1015, an input unit 1016, a LAN transmission/reception unit 1017, a connection unit 1018, a communication unit 1019, and a system bus 1020.

The processor 1011 is an arithmetic element that executes an arithmetic process. The processor 1011 controls the printer control device 1001 in accordance with software programs stored in the ROM 1012 and the storage 1014. The processor 1011 includes, for example, a central processing unit (CPU), a graphical processing unit (GPU), or the like.

The ROM 1012 is a nonvolatile memory that constitutes a part of a main memory. The ROM 1012 non-transitorily stores a start program that is necessary for starting the printer control device 1001. The ROM 1012 is composed of, for example, an erasable programmable read-only memory (EPROM), and stores various setting data at a start time, in addition to the start program.

The RAM 1013 is a volatile memory that constitutes a part of the main memory. The RAM 1013 temporarily stores a program that is necessary for the processing of the processor 1011, and data that is necessary for the execution of the program. The RAM 1013 functions as a working memory of the processor 1011.

The storage 1014 is an auxiliary storage device, and is, for example, a nonvolatile memory such as a hard disk drive (HDD) or a solid state drive (SSD). The storage 1014 non-transitorily stores a program that the processor 1011 executes, and data that is necessary for the execution of the program. Hereinafter, the program and the data necessary for the execution of the program are comprehensively referred to simply as “program”. In other words, the program includes the data necessary for the execution of the program. A program stored in the storage 1014 will be described later.

The display unit 1015 is an output device that presents information to a user and is, to be more specific, a display device that presents information to the user by display. For example, the display unit 1015 is composed of a liquid crystal display, an organic EL display, or the like.

The input unit 1016 accepts an operation of the printer control device 1001 by the user. The input unit 1016 includes a keyboard, a mouse, a key pad, a touch pad, and the like.

The LAN transmission/reception unit 1017 communicates with the printers 1002 through the LAN 1003. The LAN may be constituted by wire, or may be constituted wirelessly. For example, the LAN transmission/reception unit 1017 transmits an instruction for settings and execution of a job, such as print, to each printer 1002, and receives various information, such as model type information and setting information, from each printer 1002. For example, the LAN transmission/reception unit 1017 receives a model information file including the model type information described in an XML format type from each printer 1002.

The connection unit 1018 is a device that enables a connection to an external device. The connection unit 1018 includes, for example, a USB port, and controls an external device that is connected to the USB port. Such external devices include a USB memory, a smartphone, and the like. For example, the connection unit 1018 reads a model type information file 1040 from an external device that stores the model type information file 1040 that is output from the printer 1002.

The communication unit 1019 communicates with an external device or a cloud through a network such as a wide area network (WAN). For example, the communication unit 1019 receives a program, which is to be stored in the storage 1014, from the external device or cloud.

The system bus 1020 is a communication path between the processor 1011, ROM 1012, RAM 1013, storage 1014, display unit 1015, input unit 1016, LAN transmission/reception unit 1017, connection unit 1018, and communication unit 1019. The processor 1011, ROM 1012, RAM 1013, storage 1014, display unit 1015, input unit 1016, LAN transmission/reception unit 1017, connection unit 1018, and communication unit 1019 can transmit and receive information, data, control signals, instructions, responses and the like through the system bus 1020.

The printer control device 1001 operates by loading various software programs installed in the storage 1014 into the RAM 1013, and by the processor 1011 executing the various software programs.

For example, in the storage 1014, an operating system (OS) 1031 and a printer control program 1032 are installed.

The operating system 1031 is system software, is loaded in the RAM 1013 and executed by the processor 1011, and provides an operational base of software programs such as the printer control program 1032.

The printer control program 1032 is a software program for controlling the printers 1002. In addition, the printer control program 1032 includes various files and setting information, which are necessary for the execution of the program. The printer control program 1032 is loaded in the RAM 1013 and executed by the processor 1011, and causes the processor 1011 to execute various operations. The operations that the processor 1011 executes will be described later.

The printer control program 1032 stores set information 1033 and preset information 1035 relating to the printers 1002. The preset information 1035 includes model type information 1036. The model type information 1036 is parameter information that is preset for each of the model types of the printers 1002. The preset information 1035 may include multiple pieces of model type information 1036. The set information 1033 includes a single piece of model type information 1034. The model type information 1034 is selected from the pieces of model type information 1036 of the preset information 1035 by the user. Specifically, the model type information 1034 is one of the pieces of model type information 1036 of the preset information 1035.

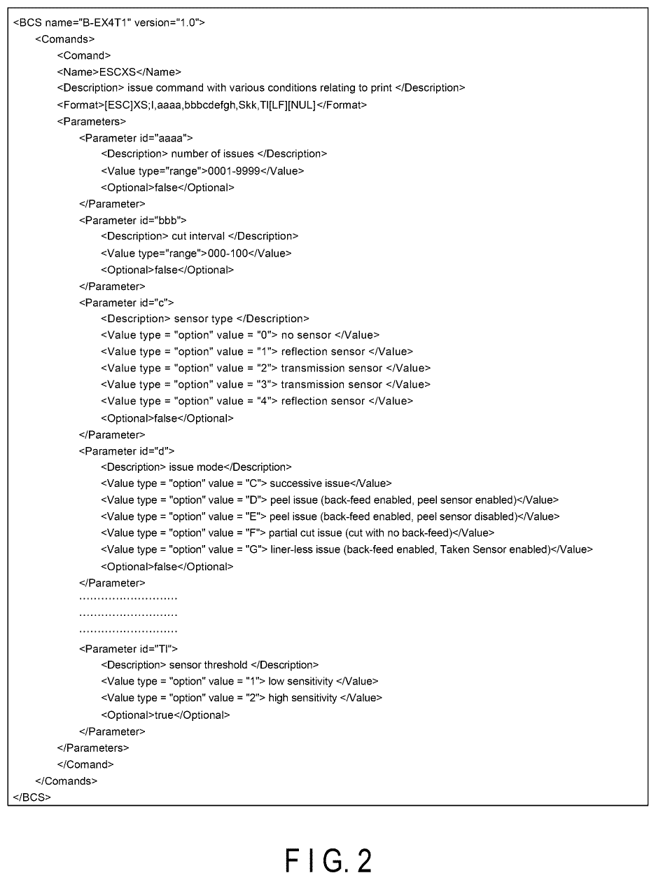

The model type information 1036 is supplied from the printers 1002. The model type information 1036 is described in the XML format type. Thus, the printer 1002 has a function of outputting the model type information 1036 in the XML format type, and the printer control device 1001 has a function of analyzing the model type information 1036 of the XML format type. FIG. 2 illustrates an example of a part of the model type information 1036 described in the XML format type.

In one example, the model type information 1036 is supplied to the LAN transmission/reception unit 1017 of the printer control device 1001 from the printer 1002 through the LAN 1003. In another example, the model type information 1036 is once output to the outside as the model information file 1040 from the printer 1002, and then the model information file 1040 is imported to the printer control device 1001. For example, the model type information 1036 is stored as the model information file 1040 in a USB memory that is inserted in the printer 1002. Thereafter, the USB memory that stores the model information file 1040 is inserted in the connection unit 1018, and the model information file 1040 in the USB memory is read in the printer control device 1001.

The program installed in the storage 1014 is provided to the printer control device 1001, for example, through a non-transitory computer-readable storage medium. For example, the program is stored in a USB memory, and the program is provided to the printer control device 1001 through the connection unit 1018 in which the USB memory is inserted. Besides, the program may be stored in a server on a network, and may be provided to the printer control device 1001 by being downloaded through the communication unit 1019 that communicates with the server.

For example, at a time of starting the computer, the processor 1011 executes the start program in the ROM 1012, and starts the OS 1031. Under the control by the OS 1031, the processor 1011 monitors the input of an instruction, a connection of the external device, and the like. In addition, under the control by the OS 1031, the processor 1011 sets a program area and a data area in the RAM 1013.

For example, by loading various function control applications stored in the storage 1014 into the RAM 1013 and executing the various function control applications, the processor 1011 controls the devices of the printer control device 1001, and controls the entirety of the printer control device 1001.

In addition, for example, by loading the printer control program stored in the storage 1014 into the RAM 1013 and executing the printer control program, the processor 1011 executes functions of the printer control.

### Operation Example

Next, an example of a printer control operation of the printer control device 1001 is described. The printer control device 1001 executes the printer control operation by the processor 1011 executing the printer control program 1032. In other words, the printer control program 1032 causes the processor 1011 execute the printer control operation.

The processor 1011 that executes the printer control program 1032 includes a function of providing a user interface (UI) that is an environment for exchanging information with the user. The interface (UI) is, for example, a graphical user interface (GUI). The graphical user interface (GUI) includes the display unit 1015 and the input unit 1016.

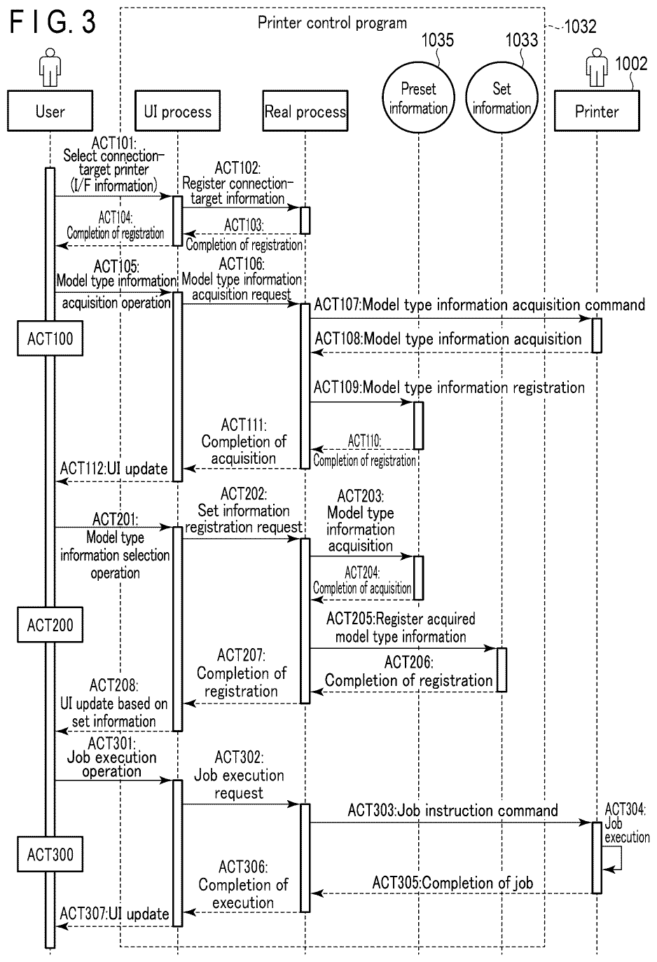

Hereinafter, referring to FIG. 3, an example of the printer control operation by the printer control device 1001 is described. FIG. 3 is a diagram illustrating an example of a sequence of the printer control operation by the printer control device 1001.

The printer control operation is executed by the processor 1011 executing various operations in accordance with the printer control program 1032. Hereinafter, for the purpose of convenience, the printer control program 1032, which causes the processor 1011 to execute various operations, is described as the subject of the operation. Specifically, that the printer control program 1032 executes a certain operation means that the printer control device 1001 executes this operation as a result of the processor 1011 executing the printer control program 1032.

The printer control program 1032 executes a UI process of performing construction, update, and the like of the UI, and a real process corresponding to a user's request through the UI.

In the printer control operation, the printer control program 1032 generally executes a model type information acquisition process (ACT 100), a model type information selection process (ACT 200), and a job instruction process (ACT 300).

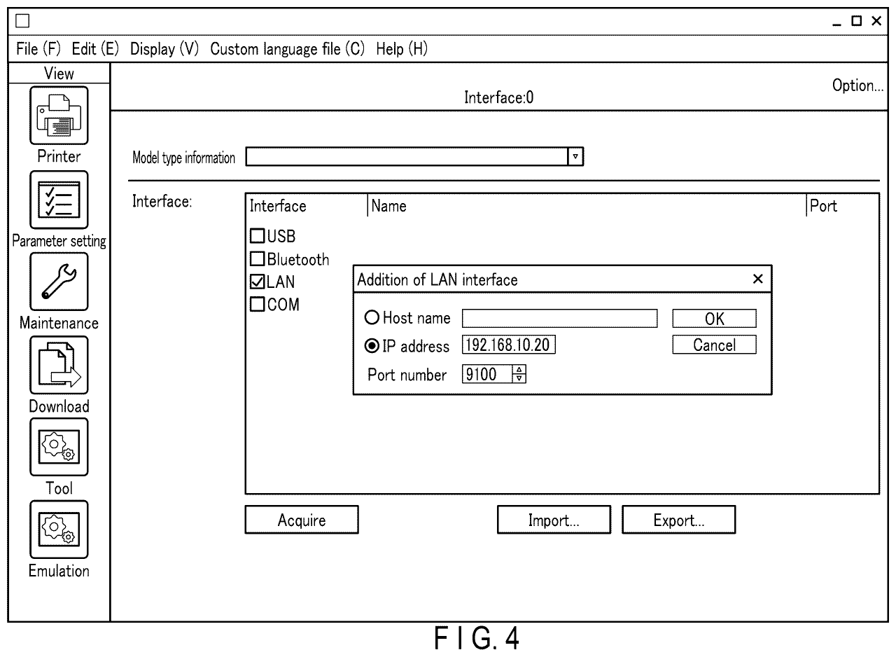

In the model type information acquisition process (ACT 100), the printer control program 1032 provides an acquisition UI to the user, the acquisition UI being an acquisition environment for acquiring model type information of the printer. FIG. 4 illustrates an acquisition UI screen of the acquisition UI that is the acquisition environment for acquiring the model type information of the printer.

On the acquisition UI screen, the user designates/selects I/F information of a LAN interface, and clicks, for example, an OK button, thereby selecting a connection-target printer (ACT 101). In this example, the I/F information of the LAN interface is an IP address and a port number.

The printer control program 1032 registers the information of the connection-target printer selected through the acquisition UI screen (ACT 102).

After the completion of registration, the printer control program 1032 notifies the user of the completion of registration through the acquisition UI screen (ACT 103, ACT 104). For example, on the acquisition UI screen, the completion of registration is notified by a pop-up.

Thereafter, for example, by clicking an acquisition button on the acquisition UI screen, the user performs an acquisition operation of the model type information 1036 (ACT 105). The model type information 1036 is parameter information that is preset for each of the model types of the printers 1002.

The printer control program 1032 receives an acquisition request for the model type information 1036 through the acquisition UI screen (ACT 106), and transmits a model type information acquisition command to the printer 1002 (ACT 107). In response, the printer 1002 that has received the model type information acquisition command transmits the model type information 1036 to the printer control device 1001, and the printer control program 1032 acquires the model type information 1036 (ACT 108).

The printer control program 1032 registers the received model type information 1036 in the preset information 1035 (ACT 109). Following the completion of registration (ACT 110) and the completion of acquisition (ACT 111), the printer control program 1032 updates the UI (ACT 112). The update of the UI does not necessarily mean a change of the UI screen, but means a change of internal parameters in the UI process. The internal parameters include, for example, information of a numerical value, a character string and the like, which are displayed on the UI screen.

By the above, the model type information acquisition process (ACT 100) is finished, and a transition occurs to the model type information selection process (ACT 200).

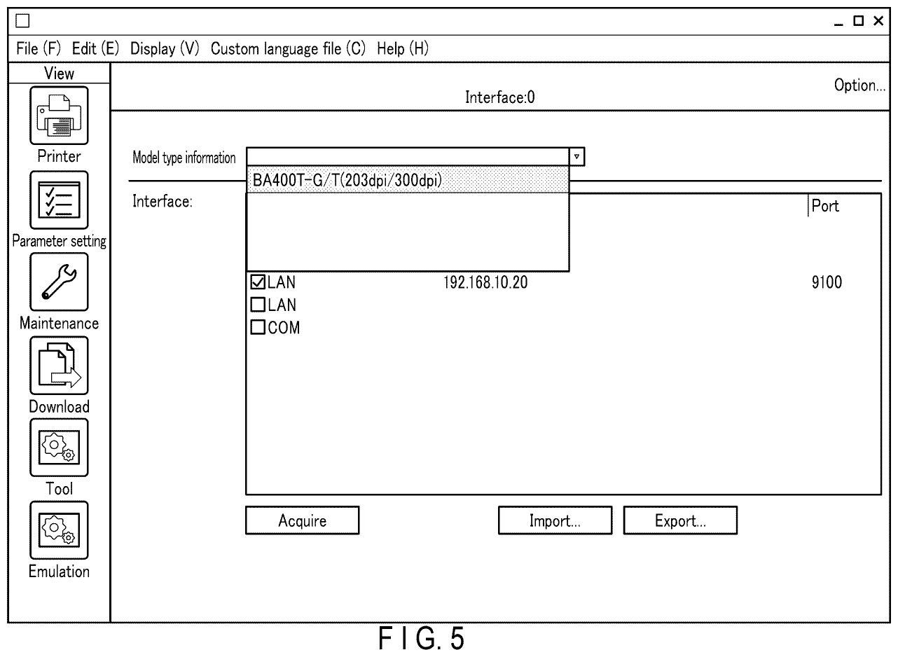

In the model type information selection process (ACT 200), the printer control program 1032 provides a selection UI to the user, the selection UI being a selection environment for selecting the model type information of the printer 1002. FIG. 5 illustrates a selection UI screen of the selection UI that is the selection environment for selecting the model type information of the printer 1002.

On the selection UI screen, the user performs a selection operation of the model type information 1036 of the printer 1002 (ACT 201). In one example, the selection operation of the model type information is performed such that an expand button of a pull-down list window is clicked, model type information is displayed in a pull-down list, and one model type information is clicked. In FIG. 5, the pull-down list displays one choice since the number of pieces of acquired model type information is one, but choices are displayed in a case where there are pieces of acquired model type information.

The selection operation of the model type information 1036 in ACT 201 is a registration request for the set information 1033. The printer control program 1032 receives a registration request for the model type information 1036 through the selection operation on the selection UI screen (ACT 202), acquires the selected model type information 1034 from the model type information 1036 of the preset information 1035 (ACT 203), and, after the completion of acquisition (ACT 204), registers the acquired model type information 1034 in the set information 1033 (ACT 205).

After the completion of registration (ACT 206, ACT 207) of the model type information 1034 in the set information 1033, the printer control program 1032 updates the UI (ACT 208), based on the set information 1033. As described above, the update of the UI means a change of internal parameters in the UI process.

By the above, the model type information selection process (ACT 200) is finished, and a transition occurs to the job instruction process (ACT 300).

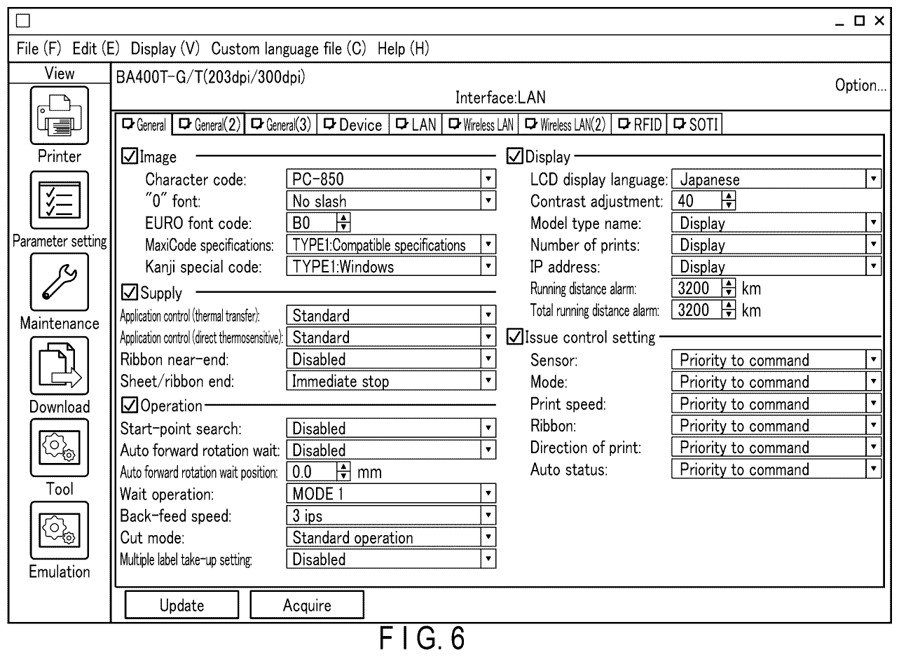

In the job instruction process (ACT 300), the printer control program 1032 provides to the user a job instruction UI that instructs a job to the printer 1002 that corresponds to the model type information 1034 registered in the set information 1033 in the model type information selection process (ACT 200). The job to the printer 1002 includes print setting update, execution of print, and the like. FIG. 6 illustrates a setting instruction UI screen of the job instruction UI for instructing a job of print setting update to the printer 1002, in a case where the job is the print setting update as an example of the job.

The setting instruction UI screen includes setting items, each of the setting items includes choices or an input field of a setting value, and default values of parameters of the model type information 1034 of the set information 1033 are reflected in the respective setting items. The user performs, as needed, a change to a choice or an input value of the setting value, and clicks, for example, an update button, thus performing a job execution operation of the print setting update (ACT 301).

The printer control program 1032 receives a job execution request for print setting update, through the job execution operation on the setting instruction UI screen (ACT 302), and transmits a job execution command for print setting update to the printer 1002 (ACT 303).

In response, the printer 1002 that has received the job execution command for print setting update updates the print setting (ACT 304), and notifies the printer control device 1001 of job completion of print setting update (ACT 305).

Upon receiving the job completion of print setting update (ACT 306), the print control program 1032 updates the UI (ACT 307). As described above, the update of the UI means a change of internal parameters in the UI process.

By the above, the job instruction process (ACT 300) of the print setting update ends. For example, thereafter, if the user requests a job instruction for print execution, the printer control program 1032 provides the print UI screen for instructing print execution to the user, and executes the job instruction (ACT 300) for print execution in the same flow as the print setting update, in regard to the job execution operation of print execution by the user.

### Advantageous Effects

In the present embodiment, the printer control program 1032 does not statically store the preset information 1035 as internal information that cannot be changed, but acquires the preset information 1035 from the printer 1002 as appropriate. Thus, there is no need to add a change to the printer control program 1032, even in a case where a change to the preset information 1035 becomes necessary due to novel model type development or version-up development of the printer 1002.

In addition, since the preset information 1035 is stored in the storage 1014, it is possible to easily adapt to an increase in the number of printers 1002 within the range of the storage capacity of the storage 1014.

Furthermore, the printer control program 1032 acquires the preset information 1035 from the printers 1002 that are completed products, and stores the preset information 1035 as changeable external information. Thus, in the stage of development, there occurs no such restriction that a detailed information exchange is needed between a development team of the printer control program 1032 and a development team of the printer 1002.

The program according to the present embodiment may be transferred in a state in which the program is stored in an electronic device, or may be transferred in a state in which the program is not stored in an electronic device. In the case of the latter, the program may be transferred through a network, or may be transferred in a state in which the program is stored in a storage medium. The storage medium is a non-transitory tangible medium. The storage medium is a computer-readable medium. The storage medium may be in any form, if the storage medium is a medium that can store a program, such as a CD-ROM or a memory card, and that can be read by a computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A non-transitory computer-readable storage medium storing a printer control program that controls a printer control device configured to control printers connected to the printer control device through a network, the printer control program causing a processor of a computer constituting the printer control device to:
provide to a user an acquisition environment for acquiring model type information that is preset for each of model types of the printers, acquire the model type information in response to an acquisition request by the user for the model type information, and register the model type information in preset information;
provide to the user a selection environment for selecting the model type information from the preset information, and register the model type information selected by the user in set information; and
provide to the user an instruction environment for instructing a job to the printer by using the set information, and instruct the job instructed by the user to the printer.

2. The storage medium of claim 1, wherein
the printer control program causes the processor to acquire the model type information from the printer through the network.

3. The storage medium of claim 2, wherein
the printer control program causes the processor to acquire the model type information through a model information file including the model type information output from the printer.

4. The storage medium of claim 3, wherein
the printer control program causes the processor to analyze the model information file in which the model type information is described in an XML format type to acquire the model type information.

5. The storage medium of claim 1, wherein
the printer control program causes the processor to acquire the model type information through a model information file including the model type information, the file being output from the printer.

6. The storage medium of claim 5, wherein
the printer control program causes the processor to acquire the model type information through an external device storing the model type information file output from the printer.

7. The storage medium of claim 6, wherein
the printer control program causes the processor to analyze the model information file in which the model type information is described in an XML format type to acquire the model type information.

8. The storage medium of claim 1, wherein
the printer control program causes the processor to construct user interfaces that respectively constitute the acquisition environment, selection environment, and instruction environment.

9. The storage medium of claim 8, wherein
the printer control program causes the processor to:
construct a user interface that constitutes the acquisition environment that allows the user to select a connection-target printer;
instruct transmission of the model type information to the connection-target printer selected by the user through the user interface;
receive the model type information transmitted from the connection-target printer; and
register the received model type information in the preset information.

10. The storage medium of claim 8, wherein
the printer control program causes the processor to:
construct a user interface that constitutes the selection environment that allows the user to select the model type information included in the preset information;
acquire the model type information selected by the user from the model type information included in the preset information through the user interface; and
register the acquired model type information in the set information.

11. The storage medium of claim 8, wherein
the printer control program causes the processor to:
construct a user interface that constitutes the instruction environment that can receive instruction of the job for the printer that corresponds to the model type information registered in the set information;
receive the instruction of the job by the user through the user interface; and
transmit the received instruction of the job to the printer.

12. The storage medium of claim 1, wherein
the printer is a bar code printer including a thermal head.

13. A printer control device configured to control printers connected to the printer control device through a network, comprising a computer including:
a memory configured to store a printer control program that controls the printers; and
a processor configured to execute the printer control program,
the processor being configured to:
provide to a user an acquisition environment for acquiring model type information that is preset for each of model types of the printers, acquire the model type information in response to an acquisition request by the user for the model type information, and register the model type information in preset information;
provide to the user a selection environment for selecting the model type information from the preset information, and register the model type information selected by the user in set information; and
provide to the user an instruction environment for instructing a job to the printer by using the set information, and instruct the job instructed by the user to the printer.

14. The printer control device of claim 13, wherein
the processor is configured to acquire the model type information from the printer through the network.

15. The printer control device of claim 14, wherein
the processor is configured to analyze the model information file in which the model type information is described in an XML format type to acquire the model type information.

16. The printer control device of claim 13, wherein
the processor is configured to construct user interfaces that respectively constitute the acquisition environment, selection environment, and instruction environment.

17. The printer control device of claim 16, wherein
the processor is configured to:
construct a user interface that constitutes the acquisition environment that allows the user to select a connection-target printer;
instruct transmission of the model type information to the connection-target printer selected by the user through the user interface;
receive the model type information transmitted from the connection-target printer; and
register the received model type information in the preset information.

18. The printer control device of claim 16, wherein
the processor is configured to:
construct a user interface that constitutes the selection environment that allows the user to select the model type information included in the preset information;
acquire the model type information selected by the user from the model type information included in the preset information through the user interface; and
register the acquired model type information in the set information.

19. The printer control device of claim 16, wherein
the processor is configured to:
construct a user interface that constitutes the instruction environment that can receive instruction of the job for the printer that corresponds to the model type information registered in the set information;
receive the instruction of the job by the user through the user interface; and
transmit the received instruction of the job to the printer.

20. A printer control method executed by a printer control device configured to control printers connected to the printer control device through a network, comprising:
providing to a user an acquisition environment for acquiring model type information that is preset for each of model types of the printers, acquiring the model type information in response to an acquisition request by the user for the model type information, and registering the model type information in preset information;
providing to the user a selection environment for selecting the model type information from the preset information, and registering the model type information selected by the user in set information; and
providing to the user an instruction environment for instructing a job to the printer by using the set information, and instructing the job instructed by the user to the printer.
